(19) United States
(12) Patent Application Publication
(10) Pub. No.: US 2023/0245048 A1
(43) Pub. Date: Aug. 3, 2023

(54) INTEGRATION OF AUTOMATED MULTI-RECIPIENT DELIVERY

(71) Applicant: Quadient Technologies France, Bagneux (FR)

(72) Inventor: Damien HASSE, Cabrières d?Avignon (FR)

(21) Appl. No.: 17/588,770

(22) Filed: Jan. 31, 2022

(51) Int. Cl. G06Q 10/08; G07C 9/33

(52) U.S. Cl. CPC G06Q 10/0836; G07C 9/33

(57) ABSTRACT

Systems, devices, and techniques are provided to allow for improved accuracy in recipient data stored by a parcel locker device operating at a multi-recipient location. During registration of a new recipient, the new recipient provides a registration code previously generated based upon an indication of the new recipient generated by a computerized property management system to allow for existing recipient data to be integrated in data stored in the parcel locker device.

### TECHNICAL FIELD

Embodiments disclosed herein relate to collection, synchronization, and storage of electronic data records related to automated multi-recipient delivery systems, improvements to automated computer systems for multi-recipient delivery, and data management and storage schema for the same.

### BACKGROUND

Multi-recipient delivery systems are those in which a large number of individuals, families, departments, or other recipient entities receive parcels at a common location. For example, multi-family housing such as condominiums and apartments, dormitories and other university housing, and some corporate environments receive mail for many recipients at a common location, from which each parcel is subsequently routed to the specific recipient. Some multi-recipient locations such as apartments and dormitories use mailboxes in a common mailroom, each of which is assigned to one or more recipients. Parcel carriers such as the United States Postal Service (USPS), FedEx, UPS, and the like may deliver parcels directly to each individual mailbox. In other environments, parcels may be delivered to a single delivery point and subsequently routed to appropriate mailboxes, receiving rooms, individual apartments or offices, or the like by an internal process at the multi-recipient location. For example, all parcels may be delivered to a single receiving area at a dormitory or office building, after which personnel at the dormitory or office building may direct individual parcels to the appropriate recipient.

### SUMMARY

Embodiments disclosed herein provide methods, devices, systems, and computer-readable media storing instructions for operating a parcel locker system, including receiving, by a computerized parcel locker device, an indication that a new recipient is available to receive parcels at a multi-recipient location; generating a registration code for the new recipient; storing a data record assigning the registration code to the new recipient at the parcel locker device; receiving new registration data from the new recipient, the new registration data comprising the registration code; and generating a recipient record at the parcel locker device for the new recipient, the recipient record allowing the new recipient to receive parcels at the parcel locker device.

Embodiments disclosed herein provide parcel locker devices and systems that can automatically obtain information from property management systems, for example including one or more lockers configured to store a parcel received from a carrier on behalf of a recipient; a computerized network interface; and a processor configured to, via the computerized network interface: generate and provide a registration code to the recipient; receive the registration code from the recipient; responsive to receiving the registration code, receive data from a property management system based on the registration code, the data including delivery information for the recipient; and provide notifications of parcel delivery to the recipient.

Embodiments disclosed herein provide automated, computer-implemented methods and devices for automatically registering tenants or other users in a parcel locker system based on existing data in a property management system and, more generally, obtaining or updating delivery information stored in and/or used by a parcel locker system based on existing data in one or more property management systems that manage a location at which the tenants receive parcels.

### BRIEF DESCRIPTION OF THE DRAWINGS

FIG. 1 shows a schematic illustration of an example multi-recipient delivery system including a parcel locker system and a property management system according to embodiments disclosed herein.

FIG. 2 shows processes and electronic communication flows to integrate automated parcel delivery according to embodiments disclosed herein.

FIG. 3 shows a schematic representation of a computer suitable for use with embodiments disclosed herein.

### DETAILED DESCRIPTION

Conventional parcel shipping systems typically are modeled as managing movement of a parcel from one single entity, a sender or shipper, to another recipient entity; as a result many electronic systems for managing, tracking, and providing user interfaces to parcel shipping systems treat each shipment as a one-to-one operation. Depending on how parcels are delivered to individual recipients at the multi-recipient location, new recipients may be added to delivery records through semi-automated or human entry techniques. This may result in discrepancies, inaccuracies, and out-of-date information in delivery records.

For example, when a new tenant moves into an apartment, they often update their address with mail and parcel delivery services either directly or through standard procedures, such as where the USPS will notify other carriers of an address change. The apartment building or multi-building system also may have a separate system to track tenant addresses, individual tenants, and the like. In conventional systems, it may not be noticed if these systems differ—the carriers deliver directly to each tenant, and the apartment system may be used only for internal deliveries and the like which do not involve external carriers.

However, as parcel delivery systems become more automated and rely on the use of devices and systems such as unattended parcel delivery lockers, the likelihood of a recipient address mis-match occurring, and the likelihood that such a mis-match has an actual effect on parcel delivery, increases significantly. For example, in a conventional property management system (PMS), each tenant's information is added to the PMS when they first become a tenant, typically either upon lease execution or on the first day of occupancy. When a property uses a conventional parcel locker, the tenant may need to provide their information to the parcel locker separately and independently of any information entered into the PMS. In a conventional PMS/parcel locker combination, there typically is no verification that recipient data entered by the tenant into the parcel locker matches data in the PMS. This may lead to parcels being seemingly undeliverable, for example when the recipient listed on the parcel does not exactly or approximately match the information the recipient provided to the parcel system upon registration, even where the parcel recipient information does match tenant information in the PMS. The following types of data discrepancies may occur, though these examples are illustrative and not intended to be limiting; further, although shown with respect to individual recipient names, similar errors may occur in street addresses, building names, resident names other than a primary tenant, and the like, and errors may occur in either data set:

| Type | Example PMS Data | Example Locker Data |
|---|---|---|
| Nickname | James Smith | Jim Smith |
| Nickname(s) | Jim and Sam Jones | James and Samantha Jones |
| Name changed | Alice Jones | Alice Smith |
| Typographical error | James Smith | Jame Smoth |
| Clerical error | Robert Hero | Roberto Herrero |
| Nickname/translation | Xu Qui Shi | Teddy Xu |

Although some errors may be seemingly apparent and easily correctable during parcel delivery, in general mis-matches between property management systems and parcel lockers may lead to delayed or unsuccessful delivery, may impact the usefulness or acceptance of such lockers, and may cause unnecessary work for property managers to rectify.

To address these and other potential issues caused by the growing use of parcel lockers and similar automated and semi-automated delivery systems, embodiments disclosed herein provide techniques and systems for improving the accuracy of data used by the parcel locker and, more specifically, for efficiently generating, storing, updating, and processing data by the combined PMS and locker systems when both are used by a common multi-recipient location.

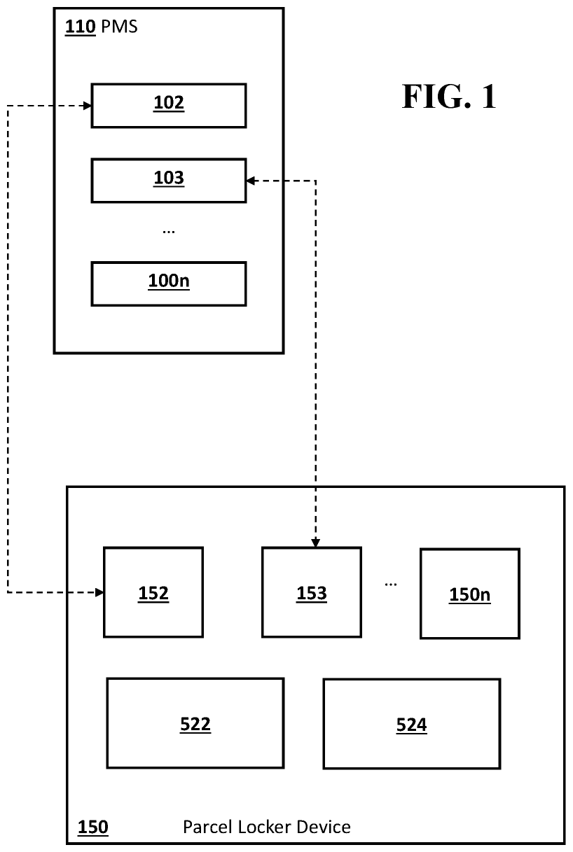

FIG. 1 shows a schematic representation of an example system that includes both a property management system and a parcel locker system. A property management system 110 may be associated with, for example, an apartment complex or several commonly-managed apartment complexes, a business office, office park, or similar, or any other location or set of locations where multiple recipients may receive parcels and other deliveries, referred to herein as a multi-recipient location. The property management system 110 may include a computerized tenant data storage system that stores electronic tenant records 102, 103, . . . 100n for each tenant of the property or properties managed by the system. Each record 102, 103, 100n may include, for example, a tenant name, address, rental agreement information, demographic information, and the like. Most importantly for the present disclosure, the records 102, 103, 100n include each tenant's “official” name for purposes of the property. In most, if not all cases, this official name is likely to be the one that is most often used for receiving parcels by the associated tenant recipient.

The property management system 110 may be located at an associated property or it may be located elsewhere, such as in a centralized administrative facility of the system's owner or in a cloud-based system. Tenant records 102, 103, 100n may be stored in the system 110 or in a remote storage system such as an off-site data warehouse, cloud-based storage system, or the like. The specific physical configuration of the computerized property management system 110 is configured and/or where tenant records 102, 103, 100n are stored is immaterial to operation of embodiments disclosed herein, and any known and suitable computer system may be used.

Parcel lockers, such as parcel locker 150 in FIG. 1, are increasingly popular in multi-recipient locations, as well as for unattended delivery and shipping in other contexts. A parcel locker system as disclosed herein may include one or more parcel locker devices 150, each of which includes multiple lockers available for delivery of parcels. A parcel locker system also may include a centralized computer system (not shown), which may, for example, provide software updates to parcel locker devices 150, coordinate maintenance and repair of one or more parcel locker devices, and the like. Outside of the multi-recipient location context, parcel locker systems as disclosed herein may be used as an alternative delivery location for recipients that otherwise might receive those parcels at their home or office, where they may need to be left in an unsecure, unattended location. For example, instead of delivering a parcel to a recipient's door, porch, or the like when they are not at home, the parcel may be delivered to a parcel locker close to the recipient's home. The recipient is notified about the delivery and provided an alphanumeric code, barcode/QR code, or similar access code that allows the recipient to access the specific locker to which the delivery was made. Such parcel lockers may be placed at commonly-accessible areas such as grocery stores, post offices, university common areas, and the like.

When used in a multi-recipient location, a parcel locker system typically may be placed in a mailroom or similar location that is readily accessible to all recipients at the location. The operation and behavior of the locker system is similar to when it is used as an alternate delivery location, but each recipient may have constant access to a dedicated locker in the parcel locker system. As such, each individual locker may be associated with a tenant record in the PMS. For example, referring to FIG. 1, tenant record 102 may be associated with a particular locker 152 in the parcel locker system 150, tenant record 102 may be associated with locker 153, and so on for each tenant 100n and associated locker 150n. Each tenant then may have access to retrieve parcels delivered to their associated locker, for example by entering an access code designated for the tenant and/or the associated locker.

Alternatively or in addition, some lockers may not be associated with a dedicated tenant record but may be available for use with any delivery. For example, each locker in the parcel locker device may be available for any delivery. After a parcel is delivered to a locker, the associated tenant may be given access to that locker, such as by using a tenant-specific code that the parcel locker device temporarily associates with the delivery locker, or by providing the tenant with a one-time-use code that accesses the appropriate locker, or any other suitable mechanism. The parcel locker device may include a range of locker sizes to accommodate various sizes of parcels. For example, the parcel locker device 150 shown in FIG. 1 may include several lockers of a particular standard size that is suitable for most routine parcel deliveries, such as lockers 152, 153, . . . 150n, and other lockers of varying sizes 522, 524, which may accommodate larger packages. In embodiments in which the standard lockers 152, 153 are assigned to specific tenants, the non-standard-size lockers 522, 524 may be available for use with any parcel delivered to any tenant, for example by providing the tenant with a one-time-use code, temporarily associating the non-standard locker 522, 524 with an existing tenant record, or the like.

Regardless of whether lockers are assigned to individual tenants or made available on an as-needed basis, it is desirable for the parcel locker system 150 and the property management system 110 to have common recipient data to make sure that parcel deliveries to the parcel locker 150 are made to proper recipients. A parcel locker system typically includes a registration process during delivery information such as each tenant's individual or business name and delivery address to the parcel locker, which stores the information in an internal computerized record system. Each carrier attempting delivery to the parcel locker 150 indicates an intended recipient so that the parcel locker 150 can provide temporary access to a suitable locker, whether dedicated or commonly used and currently available at the time of delivery. In conventional multi-recipient locations that use conventional property management systems, the synchronization of data, if any, is handled by human users, typically property managers. More commonly, new tenants register directly with the parcel locker system to provide their delivery information, separately provide change-of-address information to the USPS and/or other carriers, and separately provide their personal information to the property manager. As a result, data discrepancies as previously disclosed may be common among the property management records and those of the parcel locker system.

To address these and other data-related issues caused by the increasing use of parcel locker devices and systems, embodiments disclosed herein provide parcel locker devices, systems, and techniques that include secure, reliable techniques to synchronize tenant recipient data between existing property management systems and parcel locker devices.

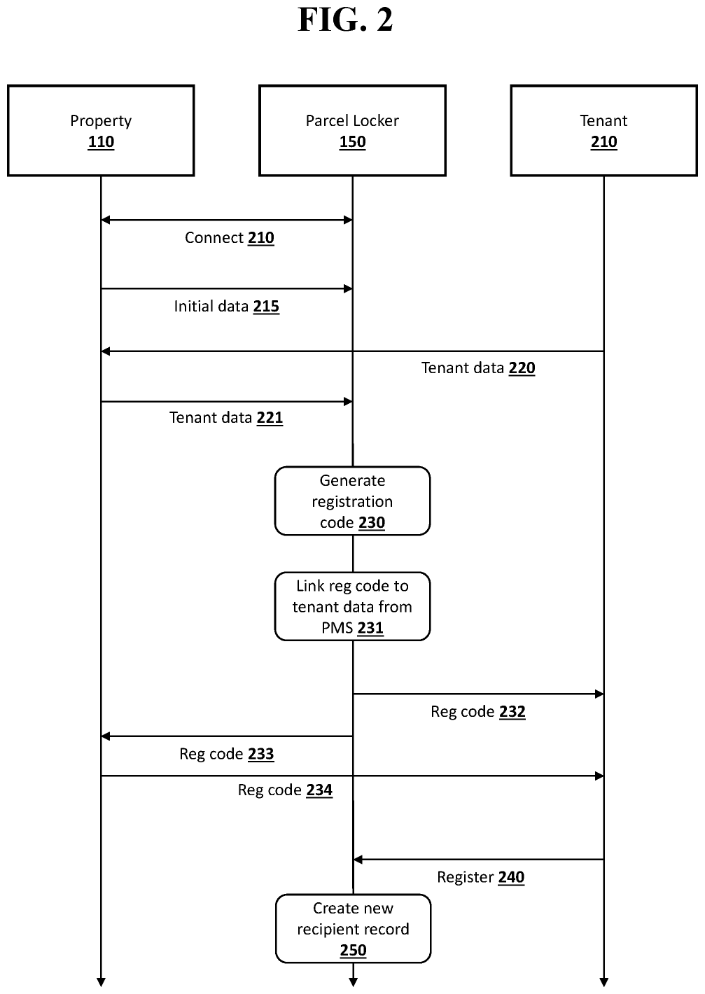

FIG. 2 shows an example process for extracting data from a property management system and accurately storing and/or updating associated tenant recipient data in a parcel locker device operating at a multi-recipient location. At 210, the parcel locker system 150 may be communicatively coupled to a computerized property management system 110, for example via an application programming interface (API) provided by the PMS 110. Such a connection allows the parcel locker system and/or individual devices 150 to access information provided by the PMS.

At 215, the parcel locker may request, and the PMS 110 may provide, initial tenant recipient information to the parcel locker 150. For example, the PMS 110 may provide a set of data for current tenant recipients which is then stored by the parcel locker 150. Each tenant recipient may then be registered using the following process, or initial registration data may be generated in bulk.

For ease of illustration, data sent from the PMS 110 to the parcel locker 150 in FIG. 2 is shown as originating from the PMS 110. However, it will be understood that in some or all cases the transfer of data from the PMS 110 to the parcel locker 150 may occur in response to an initial request by the parcel locker 150, such as via an API call. Accordingly, unless explicitly indicated to the contrary or required by other features described herein, any transfer of data from the PMS 110 to the parcel locker may be made in response to a corresponding request sent by the parcel locker 150 to the PMS 110.

At 220, the PMS 110 may receive data for a new tenant recipient 210. For example, a tenant may establish a new residence or business location at a property managed by the PMS 110, such as when a new tenant moves into an apartment complex, a business opens a new office in an office building or park, or the like. The new tenant recipient 210 may provide various personal information to the PMS 110 at 220, such as the tenant's name and mailing address, which also may be designated in whole or in part by the PMS 110.

At 221, the PMS 110 may notify the parcel locker 150 that a new tenant recipient should be added, for example by sending a notification via the API and/or providing the basic tenant information such as name and delivery address.

At 230, in response to a notification 221 that a new tenant should be added to the parcel locker stored data, the parcel locker 150 may generate a registration code for the new tenant recipient. The registration code may be generated sequentially or using any suitable algorithm that is unlikely to produce collisions. Other requirements may be imposed on the registration code algorithm to simplify use of the parcel locker registration system for tenant recipient end users. For example, the size of the code may be limited to 4, 6, 8, or any other desired number of characters; the code may be limited to numbers instead of alphanumeric characters to simplify entry via a keypad, mobile device, or the like; a library of short phrases may be used to generate the registration code to enable easy memorization by the end user; or the like.

In some embodiments, other techniques may be used to generate and manage registration codes. For example, a set number of codes may be used, each of which is available to use for a only limited time. When a code is used, it may be temporarily deactivated for a period of time, such as a day, week, several weeks, or the like, such as by storing an indication that the code is currently in use in a database. The database may store all possible codes to be used, such as where all possible six-digit codes are pre-generated and stored in the database with an indication of the current status of each. Such a technique may be particularly suited, for example, to embodiments in which a limited number of characters or digits is desired for the registration code. In some embodiments, codes that are considered easy to guess may be omitted from the database or omitted from use as registration codes. Such codes may include those having simple or common patterns, repeated numerals, or the like, such as 000000, 111111, 1234, 98765, AAAA, ABCD, and the like. The set of possible codes or the set of available codes may be stored in any suitable database or similar storage device, such as a deterministic database, encrypted lookup table, or the like.

After a registration code is generated at 230, the parcel locker 150 may link the registration code to the data received from the PMS at 221 and then send the registration code at 232 to the new tenant 210. Alternatively or in addition, the registration code may be provided to the PMS at 233, who then provides the code to the tenant at 234. For example, the code may be provided to the tenant 210 by the PMS 110 as part of a new tenant registration package, welcome email or text message, or similar information.

At 240, the new tenant recipient registers with the parcel locker using essentially a conventional registration process, but also providing the registration code received at 232/234. For example, the new tenant may provide the initial registration code received at 232/234 to the parcel locker system. The parcel locker system may use this code to obtain tenant information from the PMS, for example by requesting data from a PMS database via an API or similar interface. The tenant also may be prompted to provide other information related to the parcel locker registration. For example, the new tenant may set up initial delivery preferences, provide any common nicknames or other potential delivery names, or the like. After registration, a user also may make changes such as adding other occupant recipients, for example via a mobile application, an interface on the parcel locker system, or the like. In embodiments disclosed herein, the registration code and associated tenant data received by the parcel locker at 221 is then linked to the new tenant registration at the parcel locker 150. In the case of discrepancies between data provided by the new tenant recipient at 240 and the data received at 221, the parcel locker may ask the new tenant to confirm the correct data that should be stored for parcel deliveries. Alternatively or in addition, the parcel locker 150 may store some or all of the possible alternatives for the new tenant recipient, thereby allowing for delivery to the tenant recipient regardless of the specific delivery information assigned to the parcel by the sender or the carrier. At 250, the parcel locker 150 may generate a new recipient record for the tenant 210. Alternatively or in addition to the registration process described above, the parcel locker system 150 may synchronize information with the PMS 110 on a periodic basis, such as one or more times daily, every set number of days, once a week, or the like. For example, new tenant registrations and/or updates may be received from the PMS based on registration codes as previously described, and/or as periodic updates to data already stored in the parcel locker system.

Once the new tenant recipient is registered with the parcel locker and the new recipient record has been created at the parcel locker device 150, carriers may deliver parcels to the locker using the stored delivery information that has been verified as correct using the registration process disclosed with respect to FIG. 2. When a carrier delivers a parcel to the parcel locker system, the system may notify the recipient based upon data obtained during the registration process and/or any subsequent updates from the PMS. For example, the parcel locker system may notify a tenant that a parcel has been received and provide an access code for the parcel. The notification may be sent via email, voice, text message, or any other suitable medium, using contact information obtained from the PMS using any of the processes disclosed herein. When The tenant may then collect the parcel from the locker using the access code provided by the parcel locker. Individual parcel access codes may be managed using any suitable technique, including those previously disclosed with respect to the initial registration code.

Notably, embodiments disclosed herein improve the accuracy and reliability of tenant recipient data stored by the parcel locker, and thereby reduce the chance of erroneous deliveries or undeliverable parcels that otherwise would not be matched by the parcel locker when using conventional registration and data storage techniques. This also reduces unnecessary resource use, since fewer parcels need to be returned to the original senders. In contrast, conventional systems may have a higher occurrence of unavailable or unknown recipients when recipient information held by the carrier does not match information initially provided by the recipient during registration with the parcel locker. By integrating data stored by the parcel locker with new tenant intake processes performed by a property management system, the data stored by the parcel locker is also more likely to be up-to-date with regard to tenants being added to or removed from the multi-recipient location, such as when residential or business tenants move in or out of a location, or change address within the same location. Such changes otherwise may not be properly reflected in the parcel locker, again leading to inaccuracies in data and mis-deliveries in conventional systems.

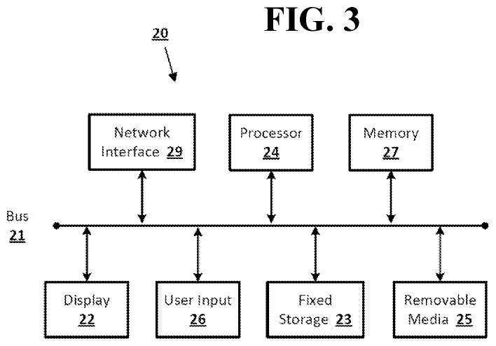

Embodiments disclosed herein may be implemented on a range of computer systems. FIG. 3 shows an example of a general- or specific-purpose computing device 20 suitable for implementing embodiments disclosed herein. For example, the device 20 may be used to implement a parcel locker control system, a computerized property management system, or the like. The device 20 may be, for example, a desktop or laptop computer, a mobile computing device such as a smart phone, tablet, or the like, or an embedded computing system, such as a system embedded in a parcel locker that is accessible by end users only through a limited-function interface. The device 20 may include a bus 21 which interconnects components of the computer 20, such as a central processor 24, a memory 27 such as Random Access Memory (RAM) and/or Read Only Memory (ROM), flash RAM, or the like, a user display 22 such as a display screen, a user input interface 26, which may include one or more controllers and associated user input devices such as a touch screen, code entry keypad as disclosed herein, or the like, a fixed storage 23 such as a hard drive, flash storage, and the like. The device may include a removable media component 25 operative to control a flash media reader or the like, for example to allow for local administrators to load updated software into a parcel locker device as disclosed herein. The device may include a network interface 29 operable to communicate with remote devices via a suitable network connection such as via the Internet. For example, a parcel locker as disclosed herein may communicate with a central parcel locker system and/or a property management system as disclosed herein. The network interface 29 may provide such connection using any suitable technique and protocol as will be readily understood by one of skill in the art, including digital cellular telephone, Wi-Fi, Bluetooth®, near-field, and the like. For example, the network interface 29 may allow the device to communicate with other computers via one or more local, wide-area, or other communication networks, as described herein.

The bus 21 allows data communication between the central processor 24 and one or more memory components 25, 27, which may include RAM, ROM, and other memory, as previously noted. Applications resident with the computer 20 are generally stored on and accessed via a computer readable storage medium.

Various embodiments of the presently disclosed subject matter may include or be embodied computer-implemented processes and apparatuses for practicing those processes. Embodiments also may be embodied in the form of a computer program product having computer program code containing instructions embodied in non-transitory and/or tangible media or any other machine readable storage medium, such that when the computer program code is loaded into and executed by a computer, the computer becomes an apparatus for practicing embodiments of the disclosed subject matter. When implemented on a general-purpose microprocessor, the computer program code may configure the microprocessor to become a special-purpose device, such as by creation of specific logic circuits as specified by the instructions. Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware.

The foregoing description, has been described with reference to specific embodiments for purpose of explanation and illustration. However, the illustrative discussions presented herein are not exhaustive and are not intended to limit embodiments of the disclosed subject matter to the precise forms disclosed. Many modifications and variations are possible in view of the above teachings without departing from the scope and content of the present disclosure. The embodiments presented herein explain the principles of embodiments of the disclosed subject matter and their practical applications, to thereby enable others skilled in the art to utilize those embodiments, and other embodiments with appropriate modifications may be similarly suited to the particular use contemplated and disclosed herein.

1. A method of operating a parcel locker system in signal communication with a computerized property management system, the method comprising:
receiving, by a computerized parcel locker device, an indication that a new recipient is available to receive parcels at a multi-recipient location managed by a computerized property management system;
generating a registration code for the new recipient;
subsequent to generating the registration code, providing the registration code to the computerized property management system managing the multi-recipient location;
storing a data record assigning the registration code to the new recipient at the parcel locker device;
subsequent to providing the registration code to the computerized property management system, receiving new registration data from the new recipient, the new registration data comprising the registration code provided to the computerized property management system; and
generating a recipient record at the parcel locker device for the new recipient, the recipient record allowing the new recipient to receive parcels at the parcel locker device.

2. The method of claim 1, further comprising:
subsequent to generating the registration code and prior to receiving the new registration data from the new recipient, providing the registration code to the new recipient.

3. (canceled)

4. The method of claim 1, wherein the registration code is an alphanumeric code selected from a predefined set of registration codes.

5. The method of claim 4, wherein the parcel locker device comprises a keypad sufficient to enter the alphanumeric code.

6. The method of claim 4, wherein the registration code comprises not more than 6 characters.

7. The method of claim 1, further comprising:
receiving tenant data for the new recipient from the property management system, the tenant data comprising at least a recipient name for the new recipient.

8. The method of claim 7, further comprising:
comparing at least some of the new registration data to the tenant data and identifying one or more discrepancies.

9. The method of claim 8, further comprising:
subsequent to receiving the new registration data and prior to generating the recipient record by the parcel locker device, prompting the new recipient to correct the one or more discrepancies and generating the recipient record based at least in part a correction provided by the new recipient.

10. The method of claim 8, wherein the recipient record comprises alternate recipient data based upon the one or more discrepancies.

11. A computerized parcel management system comprising:
a parcel locker device comprising:
one or more lockers configured to store a parcel received from a carrier on behalf of a recipient;
a computerized network interface; and
a processor configured to, via the computerized network interface:
generate a registration code for the recipient;
subsequent to generating the registration code, provide the registration code to a computerized property management system managing a multi-recipient location;
subsequent to providing the registration code to the computerized property management system, receive the registration code from the recipient;
responsive to receiving the registration code, receive data from a property management system based on the registration code, the data including delivery information for the recipient; and
provide notifications of parcel delivery to the recipient.

12. The system of claim 11, further comprising:
the property management system, wherein the property management system comprises a database configured to store tenant delivery information.

13. The system of claim 11, further comprising a database storing a plurality of possible registration codes including the registration code.

14. The system of claim 13, wherein the parcel locker device comprises the database.

15. The system of claim 13, wherein the database is remote from the parcel locker device.

16. The system of claim 11, the parcel locker device further comprising a keypad sufficient to enter the registration code.
